(19) United States
(12) Patent Application Publication
(10) Pub. No.: US 2013/0106989 A1
(43) Pub. Date: May 2, 2013

(54) CLOUD-BASED INTEROPERABILITY PLATFORM FOR VIDEO CONFERENCING

(71) Applicant: Teliris, Inc., New York, NY (US)

(72) Inventors: Steven Gage, Merrick, NY (US); Aravind Sethuraman, Piscataway, NJ (US); Lou Chiorazzi, New York, NY (US)

(73) Assignee: Teliris, Inc., New York, NY (US)

(21) Appl. No.: 13/666,373

(22) Filed: Nov. 1, 2012

Related U.S. Application Data
(60) Provisional application No. 61/554,365, filed on Nov. 1, 2011.

(51) Int. Cl. H04N 7/15

(52) U.S. Cl. CPC H04N 7/152
USPC 348/14.09

(57) ABSTRACT

Embodiments of the present disclosure relate to a distributed video conference system that allows for distributed media routing and contextual provisioning of a conference based upon static and dynamic variables in real-time, moderator control, and/or user control. In embodiments, the distributed video conference system provides a cloud-based interoperability platform that different endpoints having different capabilities can access to participate with each other in a conference. Contextual provisioning may be employed to adjust the settings for a conference and to select the different components (e.g., hardware and software components) that are employed in the conference. A decision engine may perform the contextual provisioning in real-time to provide an optimal conference experience based upon static and dynamic variables.

### PRIORITY

This application claims priority to U.S. Provisional Patent Application No. 61/554,365, entitled “Cloud-based Interoperability Platform for Video Conferencing,” filed on Nov. 1, 2011, which is hereby incorporated by reference in its entirety.

### BACKGROUND

Conferencing systems generally employ specialized hardware known as multipoint control units (MCU's) to support video and/or audio conferencing. A problem with MCU's are that they are generally expensive, are capable of handling limited types of communication protocols or codecs, and generally are limited in the number of simultaneous connections that they can support with other hardware devices in a conferencing system. The use of specialized hardware in conferencing systems makes it difficult to support new communication protocols as they are developed and to scale conferencing systems to meet client needs. It is with respect to this general environment that embodiments disclosed herein have been contemplated.

### SUMMARY

Embodiments of the present disclosure relate to a distributed video conference system that allows for distributed media routing and contextual provisioning of a conference based upon static and dynamic variables in real-time. In embodiments, the distributed video conference system provides a cloud-based interoperability platform that different endpoints having different capabilities can access to participate with each other in a conference. For example, endpoints employing devices with different capabilities ranging from video capability, 2D/3D capability, audio capability, different communication protocol support, etc., can communicate with each other using the distributed video conference system. As used throughout the disclosure, an endpoint may comprise one or more devices or systems (e.g., a computer or a conference room comprising multiple cameras). In other embodiments, an endpoint may be related to a customer account that provides different capabilities based upon a service provider or service provider package.

In embodiments, contextual provisioning may be employed to adjust the settings for a conference and to select the different components (e.g., hardware and software components) that are employed in the conference. A decision engine may perform the contextual provisioning in real-time to provide an optimal conference experience based upon static and dynamic variables.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 is an embodiment of a distributed conferencing system 100 that may be employed to create a cloud-based interoperability platform for conferencing.

FIG. 2 is an alternate embodiment of a distributed conferencing system 200 that may be employed to create a cloud-based interoperability platform for conferencing.

FIG. 3 is an embodiment of a method 300 to initiate conference for an endpoint.

FIG. 4 is an embodiment of a method 400 for contextual provisioning.

FIG. 5 is an embodiment of a method 500 for transcoding conference information.

FIG. 6 is an embodiment of a method 600 that to convert media transfer streams to one or more native format streams supported by one or more endpoint devices.

FIG. 7 illustrates an embodiment of a computer environment and computer system 700 for implementing the systems and methods disclosed herein.

### DETAILED DESCRIPTION

Embodiments of the present disclosure relate to a distributed video conference system that allows for distributed media routing and contextual provisioning of a conference based upon static and dynamic variables in real-time. In embodiments, the distributed video conference system provides a cloud-based interoperability platform that different endpoints having different capabilities can access to participate with each other in a conference. For example, endpoints employing devices with different capabilities ranging from video capability, 2D/3D capability, audio capability, different communication protocol support, etc., can communicate with each other using the distributed video conference system. As used throughout the disclosure, an endpoint may relate to one or more devices (e.g., a computer or a conference room comprising multiple cameras) employing one or more codecs. In other embodiments, an endpoint may be related to a customer account that provides different capabilities based upon a service provider or service provider package.

A distributed conferencing system provides many advantages over prior conferencing system. In embodiments, the distributed conferencing system may be used to host video conferences or other types of conferences, such as, but not limited to, conferences that include multimedia data (e.g., documents, slides, etc.). Video conferences may include streams of both audio data and video data. A distributed conferencing system may utilize general hardware components rather than conference specific hardware such as a multipoint control unit (MCU). Distributed conferencing systems provide scalability; that is, a distributed conferencing system can quickly be scaled up to support a larger number of conferences and participating devices. Additionally, a distributed conferencing system reduces the distance between an endpoint one or more conference components. Ideally, the distance between an endpoint and a conference component is minimal. For example, providing a conferencing component in near geographic or network proximity to an endpoint provides lower latency and improved error resilience. As such, it is desirable to provide as little distance as possible between the endpoints and the conferencing components. While the conferencing components may be connected by a high-speed, high quality network, the endpoints generally communicate with the conferencing system over a lower quality network. Thus, greater conference quality can be achieved by reducing the distance that data travels between an endpoint and a conferencing component over a low quality network.

Distributed conferencing systems provide multiple benefits. For example MCU's generally are incapable of simultaneously transmitting multiple streams of data to multiple MCU's involved in a conference. Instead, MCU's transmit a stream to a single MCU, thereby requiring all participants in a conference to communicate with one of the MCU's and to use a single communications protocol. The present disclosure, however, provides a distributed conferencing system to provide a cloud-based interoperability platform that allows communication between any number of components. This provides flexibility when provisioning a conference by allowing a decision engine to utilize different conference components based upon their performance capability during initial conference setup. Further, the flexibility of the distributed conferencing system allows the decision engine 106 to adjust the provisioning of the conference in real-time based upon feedback information to continually provide an optimal conferencing experience. This allows the distributed conferencing system 100 to react to changes in the system during a conference such as, but not limited to, changes in network condition, load balancing and traffic on specific components, lag experienced by different endpoints, etc., by adjusting the conference provisioning (e.g., change conference settings, migrate communications to different conference components, etc.) in real-time. Additionally, MCU's are expensive pieces of hardware, while general computing devices are not. As such, a distributed conferencing system can be scaled without incurring the cost of obtaining additional MCU's. In addition to these benefits, one of skill in the art will appreciate the benefits that the distributed conference system 100 provides over previous conferencing systems.

In embodiments, contextual provisioning may be employed to adjust the settings for a conference and to select the different components (e.g., hardware and software components) that are employed in the conference. A decision engine may perform the contextual provisioning in real-time to provide an optimal conference experience based upon static and dynamic variables related to conference performance, end point capabilities (e.g., the capabilities of one or more user devices participating in the conference), network capabilities, level of service (e.g., feature sets provided by a service provider or purchased buy a customer), and other factors. For example, static variables used in contextual provisioning may be, but are not limited to, capabilities of endpoint devices, number of cameras, number of display screens, endpoint codec support (e.g., the quality of video and audio an endpoint supports, whether the endpoint can decode multiple streams or a single stream, etc.), endpoint codec settings (e.g., resolution and audio settings), user status (e.g., whether the user purchased a business or consumer service), network capability, network quality, network variability (e.g., a wired connection, WiFi connection, cellular data or 3G/4G/LTE connections, etc.), display capabilities (e.g., 2D or 3D display), etc. While specific examples of static variables are listed and referenced in this disclosure, one of skill in the art will appreciate that the listing is not exhaustive, and other static variables may be used when performing contextual provisioning. Additional information related initializing and conducting a conference, is provided in U.S. Pat. No. 8,130,256, entitled “Telepresence Conference Room Layout, Dynamic Scenario Manager, Diagnostics and Control System and Method,” filed on Oct. 20, 2008 and U.S. patent application Ser. No. 12/252,599, entitled “Telepresence Conference Room Layout, Dynamic Scenario Manager, Diagnostics and Control System and Method,” filed on Oct. 16, 2008, both of which are hereby incorporated by reference in their entirety.

Dynamic variables may also be employed in contextual provisioning. In embodiments, a dynamic variables may relate to data about a new endpoint that joins a conference, an endpoint leaving a conference, changes in the network, changes in the number of conferences hosted by a particular component, changes in network capacity, changes in network quality, changes to the load experienced by different modules in the distributed video conference system, etc. While specific examples of dynamic variables are listed and referenced in this disclosure, one of skill in the art will appreciate that the listing is not exhaustive, and other dynamic variables may be used when performing contextual provisioning.

In embodiments, contextual provisioning is supported by making all of the data streams received by one of the conference components from an endpoint, e.g., by a media handling resource, to other conferencing components that are part of a conference (e.g., other media handling resources that are provisioned for the conference) through cascading. In embodiments, each stream may be made available by cascading the input data streams received from each endpoint to all media handling resources. In such embodiments, the distributed conferencing system differs from conferencing systems that utilize MCU's because in a conferencing system employing MCU's, each MCU sends a single composited stream of all of the endpoint data it receives to other MCU's participating in a conference. As such, unlike the embodiments disclosed herein, every separate data stream originating from an endpoint in a conference is not made available to other conference components.

A decision engine that is part of a distributed video conference system may use static and dynamic variables during the initial set up of a conference in addition to performing contextual provisioning throughout the duration of the conference. For example, decision engine may use static and dynamic variables during set up of a conference to select which modules of the distributed video conferencing system should be employed during the conference. Furthermore, the decision engine may continually monitor changes in a conference to both static variables (e.g., capabilities of devices joining or leaving the conference) and dynamic variables in real-time during the conference. The real-time monitoring provides for real-time contextual provisioning of components of the distributed conference system to provide an optimal conference experience throughout the duration of the conference.

Embodiments of the distributed conferencing system described herein may support audio and video conferencing using general computing components. Advantages are provided by utilizing general computing components to create a cloud-based interoperability platform that may easily be scaled. Previous conferencing systems generally employ specific hardware (e.g., a multipoint control unit (MCU)) to provide conferencing capabilities. MCU's are expensive pieces of hardware that are generally limited to support specific types of communication protocols, thereby making it difficult to scale a conferencing system and support endpoints that provide capabilities different from the capabilities of the MCU. Among other benefits, the embodiments disclosed herein provide increased scalability and capability support through a cloud-based interoperability platform that is based upon a distributed conferencing system that utilizes general hardware.

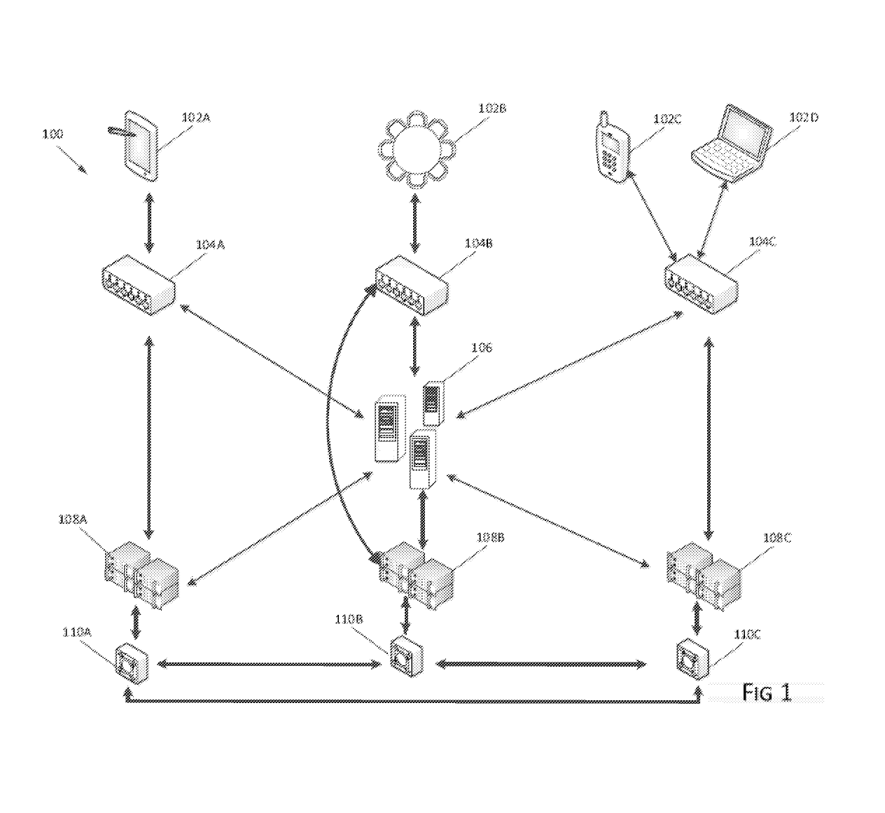

FIG. 1 is an embodiment of a distributed conferencing system 100 that may be employed to create a cloud-based interoperability platform for conferencing. The distributed conferencing system 100 may be used to provide video, audio, and/or multimedia conferencing to any number of endpoints utilizing different devices having the same or different capabilities. FIG. 1 is provided as an example of a distributed conferencing system. In other embodiments, fewer or more components may be part a distributed conferencing system 100. For example, while FIG. 1 illustrates four different endpoints (102A-102D), three different session border controllers (104A-104C), a single decision engine 106, three different media handling resources (108A-108C), and three different media transfer components (110A-110C), one of skill in the art will appreciate that some of these components may be combined or further distributed such that fewer or more of the different components illustrated in the distributed conferencing system 100 may be employed with the embodiments disclosed herein.

FIG. 1 illustrates an embodiment in which three different endpoints 102A, 102B, 102C, and 102D are connected via a distributed conferencing system 100. In the example embodiments, the three different endpoints are participating in a conference. In the example embodiment, the three different endpoints 102A-102D are participating in the same conference; however, in alternate embodiments, the three different endpoints 102A-102D may be participating in different conferences. The three different endpoints 102A-102D may employ different devices having different capabilities, or may employ similar devices having similar capabilities. In the example embodiment, endpoint 102A may employ a computing device, such as a tablet computer, a laptop computer, or a desktop computer, or any other type of computing device. Endpoint 102B may be a conference room employing conferencing equipment such as, one or more cameras, speakers, microphones, one or more display screens, or any other type of conferencing equipment. Endpoint 102C may be a phone device, such as a telephone, a tablet, a smartphone, a cellphone, or any other device capable of transmitting and receiving audio and/or video information. Endpoint 102D may be a laptop or other type of computing device. Although specific examples of devices are provided, one of skill in the art will appreciate that any other type of endpoint device may be utilized as part of an endpoint in the system 100. In embodiments, the different endpoint devices may have different capabilities that may not be compatible. For example, in embodiments, the endpoint devices may employ different communication protocols. However, as will be described in further detail below, the embodiments disclosed herein allow the different devices to communicate with each other using the distributed conferencing system 100.

In embodiments, the different endpoints may be in different regions or may be in the same region. A region may be a geographical region. For example, endpoint 102A may be located in Asia, endpoint 102B may be located in the United States, and endpoints 102C and 102D may be located in Europe. In other embodiments, each endpoint may have a different service provider or service package. In the example embodiment illustrated in FIG. 1, each component with a reference that ends in the same letter may be located in the same region, may be under the control of the same service provider, or may be part of the same service package. While the embodiment of the distributed conferencing system 100 generally shows communications between devices in the same region, using the same service provider, and using the same service package, one of skill in the art will appreciate that other embodiments exist where the different components may communicate across regions, service providers, etc. For example, although FIG. 1 illustrates endpoint 102A communicating with session border controller 104A, in other embodiments, endpoint 102A may communicate with session border controller 104B, 104C, or other components in different regions, under the control of different service providers, etc.

Each of the endpoints 102A-102D joining a conference may call into the conference. Endpoints may call into a conference to participate in the conference call. The call may contain one or more streams of data that is sent or received by one or more devices or systems that comprise the endpoint participating in the call. For example, within a single conference call a robust endpoint with multiple cameras, such as endpoint 102B, may generate multiple video streams and one or more audio streams of input data that is sent to a media handling resource, such as media handling resources 108B. By contrast, other endpoints may provide only a single input video stream and/or audio stream for a conference call. Similarly, as discussed further herein, certain endpoints may receive and decode multiple video streams and/or audio streams within a single conference call, while others (e.g., depending on the capabilities of such endpoints) may receive only a single stream of video data and/or a single stream of audio data within a particular conference call. The endpoint may continue to generate, send, and receive the one or more data streams for the duration of the call. In embodiments, an IP address of an SBC or a media resource may be used to call into a conference. In an alternate embodiment, calling into the conference may include dialing a number to join the conference. In such embodiments, a conference may be identified by a unique number.

In another embodiment, the distributed conference system 100 may be accessed generally by a unique number, and a unique extension number may be used to identify a particular conference. In another embodiment, a conference may be joined using a URL or a URI that identifies a conference. For example, the conference may be associated with a user identified by an email address or web address. An example of such a URI may be conference123@teliris.com. A conference may be joined by directing an endpoint device to the email address or web address. In such embodiments, a conference may be accessed through a web browser or an email application on an endpoint device participating in the conference. While specific example of joining a conference have been provided, one of skill in the art will appreciate that other methods of accessing a conference may be employed without departing from the disclosure.

In embodiments, each endpoint connecting to a conference may be directed to a session border controller (SBC), such as session border controllers 104A-104C. An SBC may comprise hardware components, computer-executable instructions running on a device, software, etc. In one embodiment, when attempting to initially join the conference, each device may be directed to a specific SBC. For example, endpoints in specific regions may be directed to an SBC located within their region or service provider. FIG. 1 illustrates such an embodiment where each device is directed to an SBC associated with its region or service provider. As illustrated in the example, endpoint 102A is directed to SBC 104A, endpoint 102B is directed to SBC 104B, and endpoint 102C is directed to SBC 104C. In such embodiments, the initial connection may be automatically established with a local SBC to reduce connection lag, to avoid unnecessary cost, or for convenience. However, in other embodiments, an endpoint may initially connect with an SBC in a different region, service provider, etc. For example, if the local SBC is experiencing a large amount of traffic, an optimal result may be obtained by connecting to a remote SBC that is experiencing less traffic. Such circumstances may arise based upon the time of day in a region where the SBC is located. For example, an SBC in the U.S. may be overloaded during midday, while an SBC located in Asia may experience little traffic at the same time due to the time difference. In such embodiments, the amount of traffic, or other measures such as time of day, may be used to determine which SBC receives the initial connection. Although not shown in FIG. 1, endpoints 102A-102D may communicate with SBC's 104A-104C over a network. As used throughout the disclosure, a network may be a local area network (LAN), a wide area network (WAN), a telephone connection such as the Plain Old Telephone Service (POTS), a cellular telephone or data network, a fiber optic network, a satellite network, the Internet, or any other type of network known. One of skill in the art will appreciate that any type of network may be employed to facilitate communication among the different components of the distributed conference network 100 without departing from the spirit of the disclosure.

In embodiments, the SBC may perform different actions upon initialization and through the duration of a conference depending on the type of endpoint that connects to the SBC. For example, in one embodiment, the SBC may continue to transport a stream of data to the various conference components. In such embodiments, the SBC may send information to a decision engine, but it may handle the streams itself. For example, if the SBC is communicating with a H.323 endpoint, the SBC may continue to receive and transmit media streams from the client while forwarding information to the decision engine. However, if the SBC is communicating with a session initiation protocol (SIP) endpoint, it may pass the media streams directly through to the media handling resource. One of skill in the art will appreciate that different protocols may be employed by the different embodiments, and that the actions performed by the SBC may change depending on the protocol without departing from the spirit of this disclosure.

Upon the establishment of a connection between an endpoint and an SBC, the SBC sends call information to a decision engine 106 over a network. In embodiments, the call information includes information about a particular call into the conference. The call information may include static and/or dynamic variable information. The information sent to the decision engine 106 may include, but is not limited to, conference information (e.g., a conference identifier identifying the conference the endpoint is joining), a participant list for the conference, details related to the conference such as type of conference (e.g., video or multimedia), duration of the conference, information about the endpoint such as information related to the endpoint's location, a device used by the endpoint, capabilities supported by the endpoint, a service provider for the endpoint, geographic information about the endpoint, a service package purchased by the endpoint, network information, or any other type of information.

In embodiments, the decision engine may use the information received from an SBC to perform initial contextual provisioning for the endpoint joining the conference. The initial contextual provisioning may be based upon different decision factors. For example, static factors such as information related to the number of cameras and screens supported by an endpoint, the codecs (audio, video, and communication protocols supported by the endpoint), endpoint codec settings, whether the endpoint is a business or consumer, information related to the endpoint's network (e.g., network capacity, bandwidth, quality, variability, etc.), whether the endpoint is 2D or 3D capable, etc. The decision engine 106 may also use static information about other endpoints identified as participants to the conference. In embodiments, such information may be provided with the call information, or such information may be previously gathered and stored, for example, in instances where the conference call was previously scheduled and the participating endpoints were previously identified.

In one embodiment, the decision may be based upon the nearest point of presence to the endpoint. In embodiments, a point of presence may be any device that is part of the conference system. For example, in embodiments, the decision engine 106, media handling resources 108A-108C, and media transfer components 110A-110C may all be part of the conference system to which endpoints 102A-102D connect. In embodiments, SBC's 104A-104C may also be part of the conferencing system, or may external components to the conferencing system. In embodiments, the components that are part of the conferencing system may be connected by a dedicated, high-speed network that is used to facilitate the transfer of data between the various different components. As such, data may be transmitted between the conference components at a higher rate. However, devices that are not part of the distributed conference system, such as endpoints 102A-102D may have to connect to the conferencing system using an external network, such as the Internet. A low quality network results in more errors when transmitting data, such as video streams, which negatively impact the conference quality. The external network may have lower bandwidth requirement and/or rates of data transmission, thereby resulting in lag when communicating with the conferencing system. As such, reducing use of a low quality network, such as the Internet, by directing an endpoint to the nearest conferencing component increases conference quality.

In embodiments, lag due to data transmission over an external network may be reduced by connecting an external device to the nearest point of presence that is part of the dedicated conference network. For example, the nearest point of presence may be determined based off of proximity, which may be geographical proximity or network proximity. In embodiments, geographic proximity may relate to the distance between physical location of the dedicated conference component and the endpoint. Network proximity, on the other hand, may relate to the number of servers that must be used to transmit the data from the endpoint to the dedicated conference component. Reducing the number of hops it takes to establish a communication connection with the dedicated conference component provides a better conferencing experience for the endpoint by reducing lag. As such, the decision engine 106 may determine which media handling resource, or other dedicated conferencing component, to direct the endpoint to by identifying the nearest point of presence geographically or based off network proximity. Connecting an endpoint to a point of presence within close geographic or network proximity may provide for lower latency and better error resilience.

In embodiments, service provider information may also factor into the determination performed by the decision engine 106 for the initial contextual provisioning. Examples of service provider information may include, but are not limited to, capacity of the service provider by time of day, cost per region by time of day, feature set purchased by the service provider and customer by time of day, traffic on the service provider, or any other types of service provider factors. Dynamic information may also factor into the initial contextual provisioning, such as information related to the current status of the network, the status of the different components of the dynamic conferencing system 100, current bandwidth, current traffic, current number of users, etc.

Based upon the call information received from an SBC, the decision engine determines an initial provisioning for the endpoint and directs the endpoint to a particular conference component. For example, in the illustrated embodiment, endpoint 102A is directed to media handling resource 108A and media transfer component 110A, endpoint 102B is directed to media handling resource 108B and media transfer component 110B, and endpoint 102C is directed to media handling resource 108C and media transfer component 110C. In embodiments, the decision may be determined based on proximity of the nearest points of presence. For example, endpoint 102A, media handling resource 108A, and media transfer component 110A may be located in the same geographic region or have close network proximity. However, in other embodiments, the endpoints may be directed to different media handling resources and media transfer components. The media transfer and media handling components may comprise hardware, software, or a combination of hardware and software capable of performing the functionality described herein.

In embodiments, upon determining the initial provisioning, the decision engine 106 routes the call from an endpoint to a particular media handling resource. Routing the call by the decision engine 106 may include sending an instruction from the decision engine to the SBC or to the endpoint device itself to connect to a particular media handling resource, such as media handling resources 108A-108C. In such embodiments, the call is directed from a particular endpoint, such as endpoint 102A, to a particular media handling resource, such as media handling resource 108A, as illustrated in the embodiment of FIG. 1. In one embodiment, the connection to the media handling resource may be established through the SBC, as illustrated in FIG. 1. However, in an alternate embodiment, once the initial contextual provisioning is performed by the decision engine 106, the endpoint may directly communicate with the media handling resource over a network. The decision as to whether or not the endpoint communicates directly with the media handling resource may be based upon the communication protocol used by the endpoint, a load balancing algorithm, or any other static or dynamic information considered by the decision engine 106.

In embodiments, the media handling resource, such as media handling resources 108A-108C, may be employed provide interoperability between the different devices of different endpoints, e.g., endpoints 102A-102D, that support different capabilities and/or different communication protocols. In embodiments, the media handling resource to which an endpoint device is directed is capable of supporting similar communication protocols and/or capabilities as the endpoint device. As such, the media handling resource is capable of receiving and sending streams of data (e.g., video and/or audio data) that are in a format that the endpoint device supports. In further embodiments, the decision engine 106 may communicate with a media handling resource over a network to provide instructions to the media handling resource on how to format data streams that the media handling resource provides to the endpoint device or devices.

In conferences with multiple participants or multi-camera endpoints, multiple streams of data may be transmitted, with each stream of data carrying input data (e.g., video and audio data) from each of the participants in a conference. Depending on endpoint capabilities, an endpoint device may or may not be able to decode multiple streams of data simultaneously. As used herein, a multi-decode endpoint is an endpoint that is capable of decoding multiple video streams and multiple audio streams. Components communicating with a multi-decode endpoint, such as a media handling resource, may forward multiple streams to a multi-decode endpoint. As used herein, a single-decode endpoint is an endpoint that is capable of receiving and decoding only a single stream of video data and audio data. A single-decode endpoint may be capable of receiving a single stream of data. As such, components communicating with a single-decode endpoint, such as a media handling resource, may only send a single stream of data to a single-decode endpoint. In such embodiments, if multiple streams are to be sent to the single-decode endpoint, the media handling resource may transcode the multiple streams into a single, transcoded stream and send the transcoded stream to the single-decode endpoint.

For example, referring to FIG. 1, one or more devices associated with endpoint 102A may be capable of handling only a single stream of data. Under such circumstances, as part of routing a call, decision engine 106 may instruct media handling resource 108A to format data sent back to endpoint 102A into a composite stream. A composite stream may stream of data that is formed by compositing two or more streams of data into a single stream. For example data received from endpoints 102B and 102C may be composited into a single stream by media handling resource 108A that includes information from the two endpoints. The composite stream may then be returned to a device at endpoint 102A. However, if the device or devices at an endpoint is capable of decoding multiple streams, the decision engine 106 may instruct the media handling resource communicating with the endpoint to return multiple streams to the one or more devices at the endpoint. This reduces the processing resources required by the media handling resource, thereby allowing the media handling resource to handle a larger load of traffic. It also permits endpoints that can decode multiple streams to make full use of the separate data streams, such as by displaying each separate video stream on a different endpoint device.

In embodiments, the media handling resource receives one or more input data streams from an endpoint and normalizes the one or more input data streams into one or more media transfer streams. For example, endpoints participating in the distributed conference may send different types of data streams according to different codecs. Example codecs that may be support by different endpoints include, but are not limited to, H.263 AVC, H.264 AVC, Microsoft's RT Video codec, Skype's VP8 codec, H.264 SVC, H.265, etc. While specific codecs are identified as being supported by endpoints, the supported codecs are provided as examples only. One of skill in the art will appreciate that other types codecs may be employed with the systems and methods disclosed herein. In embodiments, a media transfer stream is a stream of data formatted to be compatible with a media transfer component, such as media transfer components 110A-110C. In embodiments, the media transfer stream may be a format optimized for sharing over a network. Once the one or more data streams are normalized into media transfer streams, the one or more normalized streams may be provided to a media transfer component associated with the media handling resource. The decision engine 106 may provide instructions to the media handling resource identifying the media transfer component that the media handling resource may communicate with for a particular conference.

The normalization of the one or more data streams from the one or more endpoints results in multiple similarly formatted data streams for each endpoint input stream received by a media handling resource, thereby addressing incompatibility problems between the different endpoints which may have different capabilities and support different communication protocols. For example, in FIG. 1, media handling resources 108A-108C normalize the data streams received from endpoints 102A-102D, respectively, and provide the normalized data streams to media transfer components 110A-110C. Relays 110A-110C may transmit the normalized streams to other media transfer components participating in the conference via a network. For example, media transfer component 110A may transmit the normalized data stream received from media handling resource 108A to media transfer components 110B and 110C. Similarly, media transfer component 110B may transmit the normalized data stream received from media handling resource 108B to media transfer components 110A and 110C, and media transfer component 110C may transmit the normalized data stream received from media handling resource 108C to media transfer components 110A and 110B. As such, in embodiments, the media transfer components (e.g., media transfer components 110A-110C) may be employed to provide communication across the distributed conference system 100. In embodiments, media transfer components are capable of simultaneously transmitting multiple streams of media transfer component data to multiple media transfer components simultaneously, and receiving multiple data streams from multiple media transfer components. Furthermore, in embodiments, a media transfer component may operate on a general purpose computer, as opposed to a dedicated piece of hardware, such as an MCU.

In embodiments, multiple endpoints may rely on the same or similar conferencing components. For example, if endpoints 102C and 102D are in the same region they may share the same SBC 104C, media handling resource 108C, and media transfer component 110C. In such embodiments, the media handling resource 108C may receive one or more individual streams from one or more devices located at endpoints 102C and 102D. In such embodiments, the media handling resource 108C may create an individual normalized stream for each stream received from devices at endpoints 102C and 102D and provide the individual normalized streams to the media transfer component 110C. This allows a media transfer component, such as media transfer component 110C, to share each stream individually with the other media transfer components (e.g., media transfer components 110A and 110B) (as opposed to creating one composite stream out of streams received from endpoints 102C and 102D). This permits contextual provisioning while providing greater flexibility in providing individual, uncomposited streams to endpoints that can handle such individual streams, even if the streams originated from disparate endpoints, using different communications protocols.

In embodiments, each media transfer component transmits the received media transfers from other media transfer components participating in the conference to its respective media handling resource. In such embodiments, the media handling resource may convert the one or more received media transfers into a data stream format supported by the endpoint communicating with the media handling resource, and transmit the converted data stream to the endpoint. The endpoint device may then process the data stream received from the media handling resource and present the data to a user (e.g., by displaying video, displaying graphical data, playing audio data, etc.).

In embodiments, multiple streams that make up the input from the various endpoints participating in a conference may be cascaded. Cascading the streams may comprise making each individual input stream generated by a device at an endpoint available to each conferencing component. For example, any one of the media handling resources 108A-108C or any of the media transfer components 110A-110C may receive an individual input stream from any device from endpoints 102A-102D. As such, in embodiments, every individual input stream from each endpoint may be made available to each conferencing component. Prior conferencing systems employing MCU's did not provide this ability. In MCU conferencing systems, each MCU is only able to transmit a single stream between other MCU's. In such a system, endpoints A and B may be connected to MCU 1 and endpoints C and D may be connected to MCU 2. Because MCU 1 and MCE 2 can only transmit a single stream between each other, MCU 1 would receive a single stream CD (representing a composite of streams C and D from MCU 2), and MCU 2 would receive as single stream AB (representing a composite of streams A and B from MCU 1). Transmitting composite streams between MCU's provides many drawbacks that may result in poor quality. For example, among other drawbacks, MCU's inability to communicate multiple streams between each other removes the ability for each MCU to modify individual streams according to specific endpoint requirements and results in poor compositions of stream data. However, by providing the ability of each conferencing component to receive individual streams of data from each endpoint in a conference, the distributed conferencing system 100 does not suffer the same drawbacks as prior conferencing systems.

Once the conference is provisioned by the decision engine 106, feedback data may be received and monitored by the decision engine 106 from one or more of the media handling resources, media transfer components, SBC's or other devices involved in the conference. In embodiments, feedback information is received by decision engine 106 in a real-time, continuous feedback loop. The decision engine 106 monitors the data received in the feedback loop to provide continuous or periodic contextual provisioning for the duration of the conference. For example, the decision engine 106 uses the feedback loop to analyze data related to the conference. Based upon the data, the decision engine may adjust the parameters of the conference, for example, by sending instructions to one or more components to reduce video quality in response to lower bandwidth, to direct communication from an endpoint to a new median handling resource, to involve more or fewer conference components in the conference, etc. in order to continually provide an optimal conference experience. As such, in embodiments, the decision engine 106 is capable of altering the conference in real-time based upon decision criteria to provide the best end user experience to all attendees in a conference. In embodiments, any of the static and dynamic information described herein may be analyzed by the decision engine 106 in conjunction with decision criteria when performing real-time contextual provisioning during the conference.

Unlike an MCU system, the dynamic conferencing system 100 cascades the input stream received by each media handling resource 108A-108C from the various endpoints 102A-102D. For example, by employing cascading, the dynamic conferencing system 100 may provide every input stream from the various endpoints 102A-102D participating in a conference call to every media handling resource 108A-108C. This allows for the media handling resources 108A-108C to perform contextual provisioning as instructed by the decision engine 106 to tailor the one or more data streams that are returned to an endpoint.

In embodiments, providing access for all of the conferencing components to each endpoint data stream allows contextual provisioning to be performed such that the conference may be tailored to each endpoint. The tailoring may be based upon the capabilities of an endpoint, the network conditions for the endpoint, or any other type of static and/or dynamic variable evaluation. For example, a conference may include at least two endpoints. A first endpoint may support a low quality codec, such as, for example a low quality video recorder on a smartphone. In embodiments, a low quality codec may be a codec that is used to display video on small screens, provides low quality video, etc. The second endpoint in the conference may have a large display screen, such as a display screen in a dedicated conferencing room. Displaying a low quality video on a large screen may result in a highly degraded image presented to the user. In such embodiments, the distributed conferencing system may employ contextual provisioning to instruct the second endpoint to display a smaller view of the data from the first endpoint rather than utilizing the large display, thereby providing a better image to the second endpoint.

For example, in embodiments, endpoint 102C may be a smart phone with that supports a low quality codec. Endpoint 102C may be in a conference with a dedicated conference room such as endpoint 102B. Displaying video generated by endpoint 102C full screen on the one or more displays of endpoint 102B would result in a distorted or otherwise poor quality video display. To avoid this, the decision engine 106 may send contextual provisioning instructions to the media handling resource 108B that is communicating with endpoint 102B. Based upon the instructions, media handling resource 108B may format a data stream representing video recorded from endpoint 102C such that the video is not displayed in full screen at endpoint 102B. In another embodiment, rather than formatting the data stream, media handling resource 108B may include instructions with the data stream that instructs the one or more devices at endpoint 102B not to display the video in full screen.

In another embodiment, contextual provisioning may be employed to address network connection issues. For example, a first endpoint in a conference may have a poor quality network connection that is not capable of transmitting a quality video stream. The distributed conferencing system may employ contextual provisioning to instruct a conference component to send the audio input stream received from the endpoint without the video stream to avoid displaying poor quality images to other endpoints participating in the conference. In an alternate embodiment, the decision engine may instruct the media handling resource to send a static image along with the audio stream received from the endpoint instead of including the video stream. In such embodiments, the endpoint receiving data from the media handling resource may receive a data stream that allows it to play audio while displaying a still image. The still image may be an image produced based upon the removed video data or it may be a stock image provided by the video conferencing system. In such embodiments, the contextual provisioning may be based upon a quality of service, an instruction from a conference participant, or other criteria.

For example, the decision engine 106 may send instructions to a media handling resource 108C receiving an input stream from an endpoint 102C to convert the input stream from a video stream to an audio only stream. In embodiments, the decision engine 106 may send the instructions after determining that the endpoint 102C is communicating over a poor quality network or providing poor quality video. In another embodiment, rather than instructing the media handling resource 108C that receives the poor quality video input stream from the device to convert the input stream to audio only, the decision engine 106 may send instructions to a media handling resource communicating with another endpoint, such as media handling resource 108B instructing the resource to convert the poor quality video to an audio only data stream before sending the audio only data stream to endpoint 102B. Furthermore, if the decision engine 106 makes a determination to send only audio data, the decision engine 106, in embodiments, may also provide users the ability to override the contextual provisioning decision made by the system via an access portal. For example, a user at endpoint 102B may use a conference application to access a portal on the decision engine 106 and override the decision to send an audio only input stream by selecting an option to receive the video stream. Upon receiving the selection through the portal, the decision engine 106 may instruct the media handling resources 108B to send the video input stream to the endpoint 102B.

In yet another embodiment, contextual provisioning may be employed to correctly display video and other visual conference data (e.g., shared electronic documents) based upon the hardware employed by different endpoints. For example, a conference may involve a high quality multiscreen endpoint with high quality networking and multiple cameras. In such embodiments, contextual provisioning may be employed to send each of the multi codec images (images produced by the multiple cameras in the high quality multiscreen endpoint) to multi decode endpoints (e.g., endpoints capable of decoding multiple audio and multiple video streams), while sending a single composited stream of data to single-decode endpoints (e.g., endpoints capable of decoding only a single audio and video stream). Furthermore, in such embodiments, the distributed conferencing system may employ contextual provisioning to instruct a conferencing component to encode a single composited stream that correctly groups the multiple images from the multiple data streams of the high quality multiscreen endpoint to ensure that the composited stream correctly displays the multiple images from the high quality multiscreen endpoint.

For example, endpoints 102B and 102C may be in a conference call. Endpoint 102B is a high quality dedicated conference room that contains multiple cameras and multiple display screens. Endpoint 102C may be a single-decode endpoint that sends and receives a single stream of video data and audio data. Endpoint 102B may transmit multiple video input streams from the multiple cameras that are part of endpoint 102B. Based upon the capabilities of the device at endpoint 102C, decision engine 106 may send an instruction to media handling resource 108C to composite the multiple video input streams received from devices at endpoint 102B (through media handling resource 108B) into a single stream in a manner that correctly reconstructs the view of the conference room at endpoint 102B prior to sending a composite data stream to endpoint 102C. Because of the capabilities of the device at endpoint 102C, the device would not be able to otherwise properly reconstruct the video input streams received from endpoint 102B.

In another embodiment, a low quality endpoint may join a conference. For example endpoint 102D may join a conference already in progress among endpoints 102A-102C. Endpoint 102D may be a low quality endpoint (e.g., it may support a low quality coded or have a low quality network connection). In response to the addition of endpoint 102D, decision engine may select a different layout for the conference by provisioning different conference components (e.g., media handling resources) or by changing the formatting of the conferencing data. In embodiments, the decision engine 106 may send instructions to media handling resources 108A-108C instructing the resources to adjust the format of the conference (e.g., video quality adjustments, switching to audio only, or any other format changes) to account for the addition of the low quality endpoint 102D to the conference.

Although the distributed conference system 100 is illustrated as multiple distinct components, one of skill in the art will appreciate that the different components may be combined. For example, the media handling resource and the media transfer component may be combined into a single component that performs both functions. In embodiments, each individual component may be a module of computer-executable instructions executed by a computing device. In alternate embodiments, each component may be a dedicated hardware component. One of skill in the art will appreciate that the distributed conference system 100 may operate in a cloud-based environment that utilizes any number of different software and hardware components that perform the same and/or different functions.

In embodiments, the distributed conferencing system may provide an access portal that endpoints may use to schedule or join a conference. In one embodiment, the access portal may be an application operating on an endpoint device. In an alternate embodiment, the access portal may be a remote application run on a server accessible by an endpoint device. In embodiments, the access portal may comprise a graphical user interface that the endpoint device displays to a user. The graphical user interface may receive input from a user that allows for the scheduling of a conference, inviting attendees to a conference, joining a conference, exiting a conference, etc. In embodiments, the access portal may also be present during the conference to receive input to control the conference experience. For example, the access portal may receive commands such as muting the endpoint, changing the video quality, displaying data (e.g., displaying a document to other participants), contacting a service provider for assistance during a conference, or any other type of conference control. In further embodiments, the conferencing system may provide administrator access which can be used to change conference settings. The portal may also provide for moderator control which allows a conference moderator to receive information about the conference and to make changes to a conference while the conference is in progress. For example, the portal may provide a moderator with the ability to add or remove endpoints, to mute endpoints, or to take any other type of action known in the art. In addition a portal may provide a control that allows the user to make changes to the presentation of the conference at the user's endpoint or endpoint devices. In such embodiments, the input received by the moderator control and the user control may be used along with other decision criteria by the decision engine to perform contextual provisioning (e.g., static and dynamic variables, endpoint capabilities, etc.).

In further embodiments, the access portal may provide additional functionality such as allowing a user to view billing information, change service plans, receive and view reports pertaining to conferencing use, etc. As such, the access portal may also provide administrative options that allow for service changes and monitoring by the individual endpoints. In further embodiments, the portal may provide an administrator interface that allows for the adjustment of decision criteria that the decision engine evaluates when performing contextual provisioning. For example, the administrator interface may provide for the selection and/or definition of particular decision criteria are used for contextual provisioning, defining preferences for certain decision criteria over others, or allow for any other types of adjustments to the performance of the decision engine. The administrator portal may also allow the administrator to override decisions made by the decision engine 106 (e.g., to send a video stream that the decision engine 106 otherwise would have not sent to a particular endpoint). In embodiments, the portal may be an application resident on an endpoint device or it may be a web application resident on the decision engine or any other server that is part of the conferencing system.

As such, in embodiments, the access portal may provide three types of control based upon the permission level of the user accessing the portal. The first level of control may be an admin level. Admin level control may be used adjust overall system settings and configuration. A second level of control may be moderator control. Moderator control may be used to control settings of the entire conference. For example, the moderator control allows for adjusting settings to different components in a conference and controlling how different endpoints receive conference data. A third type of control may be user control. Use control may provide the ability to adjust settings only to the user device or to control what the user device displays. One of skill in the art will appreciate that other types of control may be employed without departing from the spirit of the disclosure.

While the embodiment of system 100 depicts a conferencing system with a four endpoints 102A-102D, three SBC's 104A-104C, a single decision engine 106, three media handling resources 108A-108C, and three media transfer components 110A-110C, one of skill in the art will appreciate that a distributed conferencing system can support conferences between more or fewer endpoints. Additionally, a distributed conferencing system may include more or fewer conferencing components (e.g., decision engines, media handling resources, media transfer components, etc.) without departing from the spirit of this disclosure.

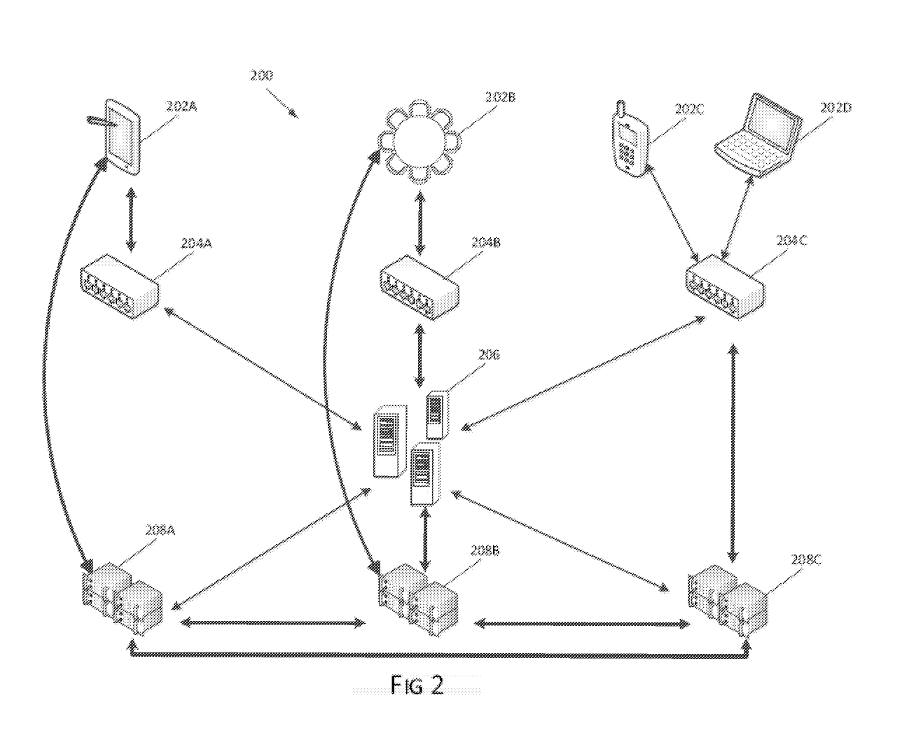

FIG. 2 is an embodiment of yet another distributed conferencing system 200 that may be employed to create a cloud-based interoperability platform for conferencing. FIG. 2 depicts an embodiment in which four endpoints 102A-102D are joined in a conference. The SBC's 204A-204C and the single decision engine 206 perform the functionality of the similar components described in FIG. 1. However, the system 200 depicts an embodiment in which one or more devices at an endpoint may communicate directly with a media handling resource after initially joining the conference, as illustrated by the communication arrow connecting endpoint 202A and media handling resource 208A. For example, during the initial provisioning of the conference, the decision engine 206 may direct endpoint 202A to media handling resource 208A. However, in embodiments, instead of establishing communication via an SBC, the endpoint may directly communicate with a media handling resource. In such embodiments, communication between the endpoint and the SBC may cease, and the SBC may no longer be a part of the conference.

FIG. 2 also illustrates an embodiment in which a conference may be conducted without use of media transfer components. In the distributed system 200, the media handling resources 208A-208C may communicate directly with one another. For example, media handling resource 208A may provide a data stream from endpoint 202A to media handling resources 208B and 208C, media handling resource 208B may provide a data stream from endpoint 202B to media handling resources 208A and 208C, and media handling resource 208C may provide a data stream from endpoint 202C to media handling resources 208A and 208B. In such embodiments, the one or more media handling resources may broadcast, unicast, or directly send data streams to other media handling resources that are part of the conference. For example, multiple unicast for AVC may be used to transmit the data from received from an endpoint between the different media handling resources. The mode of communication (e.g., mode of communication, broadcast, unicast, directed streams, which codecs to apply, etc.) established between the media handling resources may be determined by the decision engine 206. When the mode of communication is determined by the decision engine 206, the decision engine 206 may send instructions to the one or more media handling resources 208A-208C related to the mode of communication. In one embodiment, the media handling resources 208A-208C may perform a conversion on the one or more streams of data (e.g., format the stream, normalize the stream, etc.) or may pass the one or more streams of data to other media handling resources unaltered. In yet another embodiment (not illustrated in FIG. 2), each endpoint 202A-202D may simultaneously broadcast or otherwise send data streams to each media handling resource that is part of the conference. FIG. 1 and FIG. 2 show two different system employing two different methods of sharing input streams between media handling resources. However, one of skill in the art will appreciate that other system topologies and other methods may be employed to share data streams between media handling resources, or other components of a distributed conferencing system, without departing from the scope of the present disclosure.

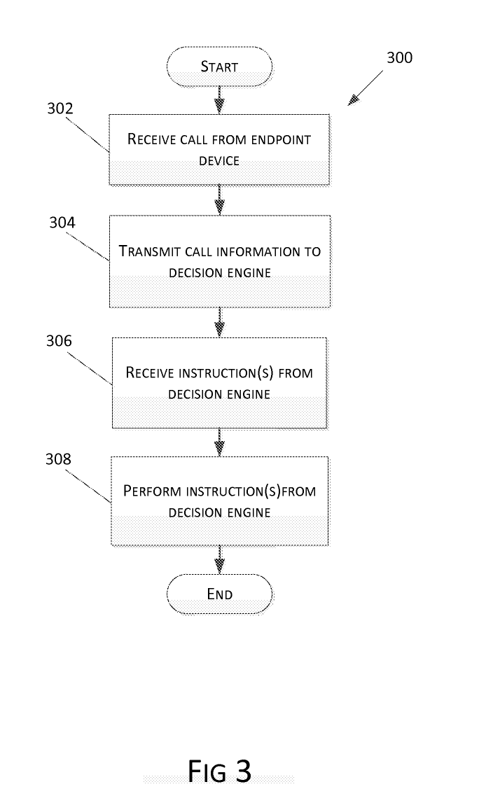

FIG. 3 is an embodiment of a method 300, which may, in embodiments, be performed by a session border controller, such as the SBC's 104A-104C of FIG. 1 and SBC's 204A-204C of FIG. 2, to initiate conference for an endpoint. In embodiments, the steps of method 200 may be performed by a dedicated piece of hardware or by software executed on a general computing device. In alternate embodiments, the steps of method 300 may be performed by computer-executable instructions executed by one or more processors of one or more general computing devices. Flow begins at operation 302 where a call is received from an endpoint device. Upon receiving the call, flow continues to operation 304 where call information is transmitted to a decision engine. In one embodiment, information about the call may be received in a data stream from the endpoint device. In another embodiment, data about the conference the endpoint is attempting to join is received from a datastore that contains information about a scheduled conference. In such embodiments, the data may be gathered and transmitted to the decision engine at operation 304 or the conference identifier may be transmitted to the decision engine, thereby allowing the decision engine to independently access information about the conference. In embodiments, any type of static or dynamic information may also be transmitted to the decision engine at operation 304 that may be utilized by the decision engine to perform initial provisioning.

After transmitting call information to the decision engine, flow continues to operation 306 where instructions are received from the decision engine. In embodiments, the instructions from the decision engine may identify a media handling resource and/or media transfer component to which the call should be routed. In another embodiment, the decision engine may also provide additional instructions that may be used by other components in the distributed conferencing system. In such embodiments, the additional instructions may be passed to such other components when routing the call.

Flow continues to operation 308, where t the instructions received at operation 306 are performed. In one embodiment, performing the instructions may comprise forwarding the call to a specific conference component identified in the instructions. This may be accomplished by forwarding the stream of data received from the endpoint device to a conference component, such as a media handling resource. In such embodiments, an SBC may maintain a connection with the endpoint device during the duration of the call. However, in alternate embodiments, an SBC may forward the call by providing instructions to the endpoint device to establish a connection with a specific conference component. The endpoint device may then establish a direct connection with the identified component, thereby ending the SBC's involvement in the conference. In such embodiments, any additional instructions received by the SBC from the decision engine at operation 306 may be transmitted to the endpoint device, which may then be transmitted to other conference components accordingly.

Upon performing the instructions at operation 308, depending on the embodiment employed, an SBC or other device performing the method 300 may end its involvement in the conference or act as an intermediary between the endpoint device and another conferencing component, such as a media handling resource. While acting as an intermediary, the SBC may facilitate communications between the endpoint device and a conferencing component thereby actively routing the call.

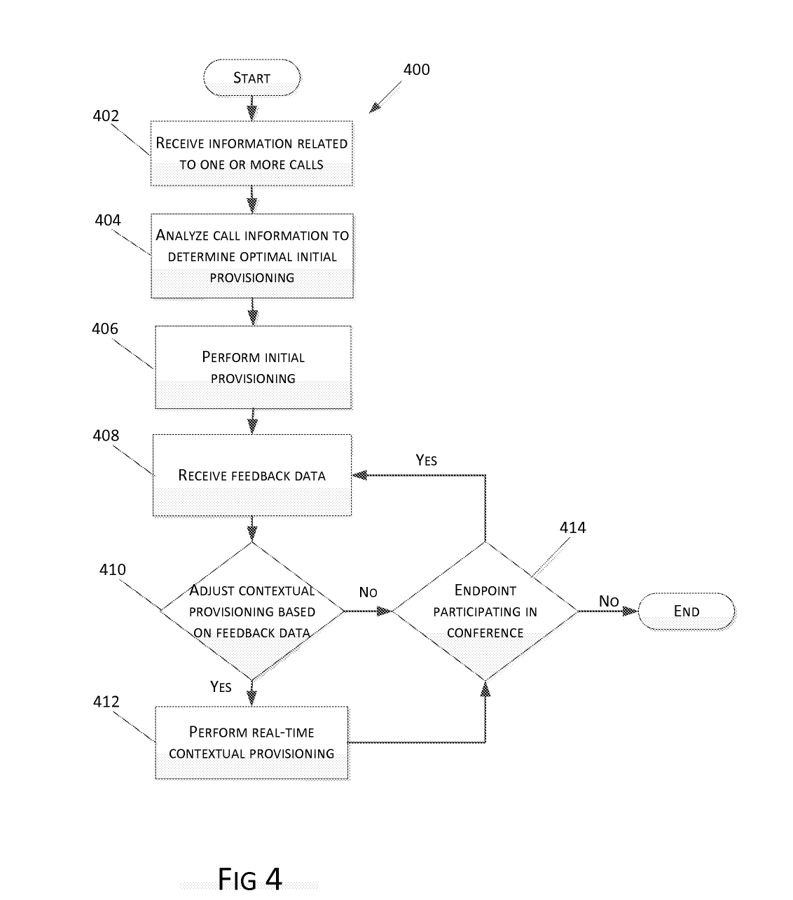

FIG. 4 is an embodiment of a method 400 for contextual provisioning. In embodiments, the method 400 may be employed by a decision engine, such as decision engine 106 and decision engine 206. In embodiments, the steps of method 400 may be performed by a dedicated piece of hardware. In alternate embodiments, the steps of method 400 may be performed by computer-executable instructions executed by one or more processors of one or more general computing devices. Flow begins at operation 402, where information is received related one or more calls attempting to join a conference. In embodiments, the data received at operation 402 may comprise information about the endpoint(s) making the call, information about the conference, information about the conference participants, and/or any other type of static or dynamic information described herein.

Flow continues to operation 404 where the information received in operation 402 is analyzed to determine an optimal initial provisioning for an endpoint joining a conference. In embodiments, the decision engine determines and/or identifies specific components of the distributed conferencing system to direct the calls toward. In addition to analyzing the call information received at operation 402, data about the distributed conference system may be received or accessed. Data about the distributed conferencing system may include data related to the current network load and traffic, workload of different components of the distributed conference system, or any other data about the distributed conference system. The data about the distributed conference system may be used, in embodiments, by the decision engine to determine an initial provisioning for an endpoint joining a conference.

Flow continues to operation 406, where based upon determination made in operation 404, initial provisioning of the endpoint is performed for a conference. In embodiments, the decision engine may perform initial provisioning by routing the call to one or more specific components in the distributed conference system. In one embodiment, routing the call may be performed directly by a decision engine at operation 406. For example, in such an embodiment, the decision engine may forward a stream of data from the call to the one or more specific components identified for initial provisioning in the determine operation 404. In another embodiment, routing the call may comprise sending instructions to an SBC that initially received the call to forward the call to one or more specific components identified in the decision operation 404. In yet another embodiment, routing the call may comprise sending instructions to one or more devices associated with the endpoint that instruct the one or more devices to communicate with one or more components of the distributed conference system.

In addition to routing the call, the initial provisioning performed at operation 406 may include defining conference settings for the endpoint participating in the conference. In one embodiment, the conference settings may be determined based upon an analysis of the static and/or dynamic information performed in operation 404. In embodiments, a decision engine may send instructions to a device associated with an endpoint at operation 406 to adhere to the determined conference settings. In further embodiments, operation 406 may also comprise sending instructions to one or more distributed conference components to adhere to specific conference settings. For example, instructions may be sent to a media handling resource provisioned to interact with the endpoint at operation 406. Such instructions may direct the media handling resource to convert streams to a particular format for consumption by the one or more endpoint devices based upon the capabilities of the one or more endpoint devices.

For example, if the one or more endpoint devices are not capable of decoding multiple input streams, the media handling resource may be instructed to format multiple streams into a composite stream that may be transmitted to the one or more endpoint devices. If, however, the one or more endpoint devices are capable of decoding multiple streams, the median handling resource may be instructed to forward multiple data streams to the one or more endpoint devices at operation 406. In embodiments, one endpoint in a conference may receive a composited stream, while another, more robust endpoint, may receive multiple streams in the same conference. In embodiments, the instructions may be sent to the one or more distributed components directly or instructions may be sent to the one or more distributed components using an intermediary (e.g., via an SBC). In still further embodiments, instructions regarding conference settings or contextual provisioning may be sent to other endpoints participating in the conference at operation 406.

Upon performing the initial provisioning at operation 406, initial conference provisioning is established for each of the one or more endpoints joining the conference as identified by the call information received at operation 402. By analyzing the call information, an optimal initial contextual provisioning is provided. However, conditions may change during the call that can affect the quality of the conference for the endpoint. In order to maintain an optimal conference experience of the endpoint for the duration of the call, real-time feedback data related to the conference is monitored and the provisioning of the conference is adjusted accordingly.

Flow continues to operation 408 where feedback data is received from one or more conference components associated with the conference. In embodiments, the feedback data is received via one or more continuous feedback loop(s) and may comprise any static or dynamic data related to the conference call. The continuous feedback loop(s) may be received from one or more conference components associated with the endpoint that was initially provisioned at operation 406. However, the method 400 may be performed for every endpoint connecting to a conference. As such, data related to the other endpoints, and the distributed conferencing system components interacting with the other endpoints, may also be received in the one or more continuous feedback loop(s) at operation 408. Furthermore, the continuous feedback loop may include information related to changes in conference participants, such as endpoints joining or leaving the conference. In such embodiments, feedback data related to every component in the conference may be received at operation 408 as well as the structure and endpoints in the conference may be received at operation 408.

Flow continues to operation 410, where the feedback data is analyzed to determine whether to adjust the contextual provisioning for the endpoint and/or components interacting with the endpoint in the conference to improve the quality of the conference. In embodiments, the determination may be based upon analyzing the feedback data to determine that the conference quality is being adversely affected. In such embodiments, if the quality is adversely affected, flow branches YES to operation 412 and real-time contextual provisioning is performed to address the adverse effects. In another embodiment, the conference may not be adversely affected, but, based on the feedback data, it may be determined that the conference quality may be improved anyway. For example, it may be determined that conference lag may be reduced by transitioning communications with an endpoint from a first conference component to a second conference component. In other embodiments, conference quality may be improved by adjusting or substituting conference components in order to optimize costs savings for the participant or the service provider. In such embodiments, YES to operation 412 and real-time contextual provisioning is performed to increase the quality of the conference. If upon analysis of the feedback data, the quality of the conference is not adversely affected and cannot be improved, flow branches NO to operation 414.

At operation 412, real-time contextual provisioning is performed. In embodiments, real-time contextual provisioning may include instructing one or more devices at the endpoint to adjust conference settings. In another embodiment, real-time contextual provisioning may comprise instructing one or more distributed conference components to adjust conference settings. In yet another embodiment, the real-time contextual provisioning may further include migrating the call from a first conference component to a second conference component. For example, the call may be migrated for load balancing purposes, due to bandwidth or performance issues related to a particular conference component, or for any other reason. In such embodiments, the one or more endpoint devices may be instructed to establish a connection with a different conference component or the conference component currently interacting with the one or more endpoint devices may be instructed to forward the call to a different conference component. As such, embodiments disclosed herein provide for performing real-time contextual provisioning based upon decision criteria analyzed against static and/or dynamic information related to the endpoints participating in a conference, the conference components, network performance, user service plan, conference structure, a change of participants to the conference, etc. In doing so, among other benefits, performance of the method 400 allows for an optimal conference experience for an endpoint involved in a conference.

Flow continues to operation 414 where a determination is made whether the one or more devices for the endpoint are still participating in the conference. If the endpoint is still participating in the conference, flow branches YES returns to operation 410 and the feedback data continues to be received. If the endpoint is no longer participating in the conference, flow branches NO, and the method 400 ends.

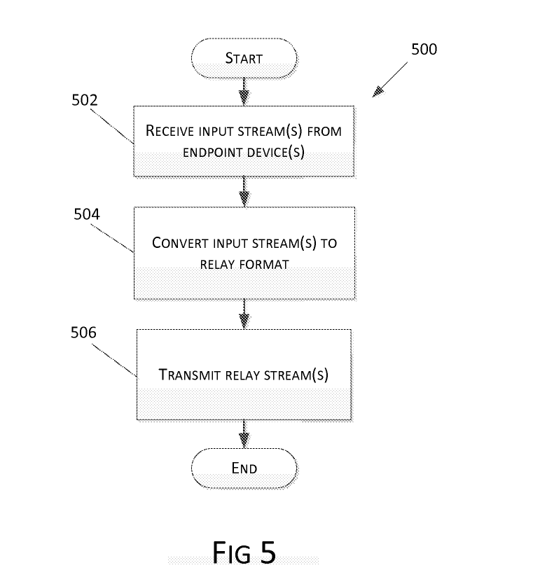

FIG. 5 is an embodiment of a method 500 for transcoding conference information. In embodiments, the method 500 may be performed in order to allow communication between one or more endpoints having different capabilities and/or supporting different communication protocols. In one embodiment, the method 500 may be performed by a media handling resource. In embodiments, the steps of method 500 may be performed by a dedicated piece of hardware. In alternate embodiments, the steps of method 500 may be performed by computer-executable instructions executed by one or more processors of one or more general computing devices.

Flow begins at operation 502 where one or more input streams from one or more devices associated with an endpoint are received. In embodiments, the one or more input streams may be in a native format that is supported by the one or more devices comprising the endpoint. Flow continues to operation 504 where the one or more input streams are converted into a media transfer format. In embodiments, the media transfer format is a format that is compatible with one or more media transfer components that are part of a distributed conference system. In embodiments, the media transfer format may be optimized for transmission across a network. In embodiments, where multiple input streams are received at operation 502, the media handling may convert the multiple input streams from a native format to a media transfer format in parallel.

Flow continues to operation 506 where the media handling resource transmits one or more streams to one or more other conference components. Transmitting the one or more media transfer formatted streams allows for the one or more input streams from different endpoint devices to be shared with other conference components, such as other media handling resources, and, ultimately, other endpoints, as described with respect to the systems 100 and 200. The sharing of the streams may also be utilized for contextual provisioning. In embodiments, the method 500 may be performed continuously by a media handling resource for the duration of the endpoint's participation in the conference. In embodiments, multiple endpoints and/or multiple endpoint devices in a conference may use the same media handling resource. In such embodiments, the media handling resource may transmit a separate stream for each endpoint and/or endpoint device and provide separate steams for each device to other media transfer component, which, in turn, may transmit the streams individually. In another embodiment, the media handling resource may transmit the streams to other media handling resources without the use of a media transfer component, for example, by broadcasting, unicasting, or any other method.

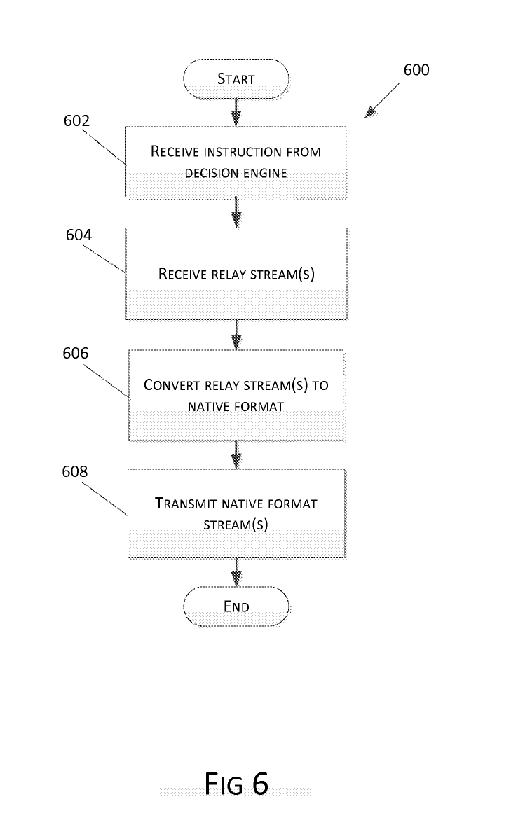

FIG. 6 is an embodiment of a method 600 to convert media transfer streams to one or more native format streams supported by one or more endpoint devices. In embodiments, the method 600 may be performed in order to allow communication between one or more endpoints having different capabilities and/or supporting different communication protocols. In one embodiment, the method 600 may be performed by a media handling resource. In embodiments, the steps of method 600 may be performed by a dedicated piece of hardware. In alternate embodiments, the steps of method 600 may be performed by computer-executable instructions executed by one or more processors of one or more general computing devices.

Flow begins at operation 602 wherein instructions are received from a decision engine. In embodiments, the instructions from the decision engine may be used to determine the format of the native format stream for one or more endpoint devices. Flow continues to operation 604 where one or more media transfer formatted streams of data are received from a one or more media transfer component. In embodiments, the one or more media transfer streams of data may be in a format compatible for the media transfer component. The one or more streams may represent input stream data from other participants (e.g., endpoints) participating in the conference. Flow continues to operation 606 where the one or more media transfers streams are converted to one or more native format streams. In embodiments, a native format stream is a format supported by one or more endpoint devices. In embodiments, the type of conversion performed at operation 606 may be determined by the instruction received at operation 602. For example, if the instruction received at operation 602 creation of a composite stream, the conference component, such as a media handling resource, may convert multiple streams in a media transfer format into a single composite stream in a native format. On the other hand, if a pass through instruction is received, multiple media transfers may be individually converted to a native format or, in embodiments where the one or more endpoint devices are compatible with the media transfer format, may not be converted at all in operation 606. Flow continues to operation 608 where the one or more converted streams are transmitted to one or more endpoint user devices directly or via an intermediary. In embodiments, the method 600 may be performed continuously by a media handling resource for the duration of the endpoint's participation in the conference.

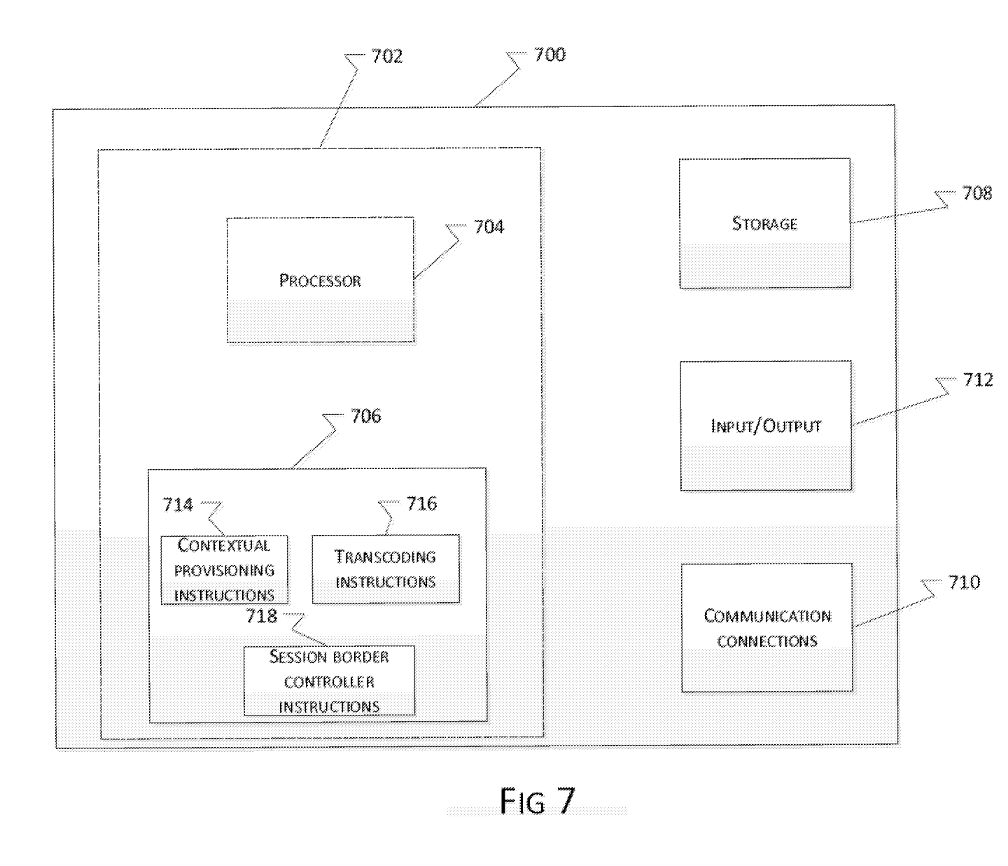

With reference to FIG. 7, an embodiment of a computing environment for implementing the various embodiments described herein includes a computer system, such as computer system 700. Any and all components of the described embodiments (such as the endpoint devices, the decision engine, the media handling resource, the media transfer component, a SBC, a laptop, mobile device, personal computer, a smart phone, etc.) may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 700 comprises at least one processing unit or processor 704 and system memory 706. The most basic configuration of the computer system 700 is illustrated in FIG. 7 by dashed line 702. In some embodiments, one or more components of the described system are loaded into system memory 706 and executed by the processing unit 704 from system memory 706. Depending on the exact configuration and type of computer system 700, system memory 706 may be volatile (such as RAM), non-volatile (such as ROM, flash memory, etc.), or some combination of the two.

Additionally, computer system 700 may also have additional features/functionality. For example, computer system 700 may include additional storage media 708, such as removable and/or non-removable storage, including, but not limited to, magnetic or optical disks or tape or solid state storage. In some embodiments, software or executable code and any data used for the described system is permanently stored in storage media 708. Storage media 708 includes volatile and non-volatile, removable and non-removable media implemented in any method or technology for storage of information such as computer readable instructions, data structures, program modules, or other data.

System memory 706 and storage media 708 are examples of computer storage media. Computer storage media includes RAM, ROM, EEPROM, flash memory or other memory technology, CD-ROM, digital versatile disks (DVD) or other optical storage, magnetic cassettes, magnetic tape, magnetic disk storage, other magnetic storage devices, solid state storage or any other tangible medium which is used to store the desired information and which is accessed by computer system 700 and processor 704. Any such computer storage media may be part of computer system 700. In some embodiments, system memory 706 and/or storage media 708 may store data used to perform the methods or form the system(s) disclosed herein. In other embodiments, system memory 706 may store instructions that, when executed by the processing unit 704, perform a method for contextual provisioning 714, methods for transcoding data 716, and/or methods performed by a session border controller 718. In embodiments, a single computing device may store all of the instructions 714-618 or it may store a subset of the instructions. As described above, computer storage media is distinguished from communication media as defined below.

Computer system 700 may also contain communications connection(s) 710 that allow the device to communicate with other devices. Communication connection(s) 710 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, instructions and data streams described herein may be transmitted over communications connection(s) 710.

In some embodiments, computer system 700 also includes input and output connections 712, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 712 are used to display the information as described herein.

In some embodiments, the component described herein comprise such modules or instructions executable by computer system 700 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of computer readable media. In some embodiments, computer system 700 is part of a network that stores data in remote storage media for use by the computer system 700.

This disclosure described some embodiments of the present invention with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the invention is not limited to those specific embodiments. One skilled in the art will recognize other embodiments or improvements that are within the scope and spirit of the present invention. Therefore, the specific structure, acts, or media are disclosed only as illustrative embodiments. The scope of the invention is defined by the following claims and any equivalents therein.

What is claimed is:

1. A method for performing contextual provisioning in a video conference, the method comprising:
receiving, at a decision engine, information about a first call from a first endpoint of the video conference;
sending instructions to route the first call to an identified first media handling resource, wherein the first media handling resource is identified based upon proximity to the first endpoint;
receiving, at the decision engine, information about a second call from a second endpoint of the video conference, wherein the information about the first call and the information about the second call indicate that the second endpoint supports a set of capabilities different from the first endpoint;
sending instructions to route the second call to an identified second media handling resource, wherein the second media handling resource is identified based upon proximity to the second endpoint;
receiving feedback data related to the conference;
analyzing the feedback data; and
based upon the analysis, performing contextual provisioning to increase the quality of the conference.

2. The method of claim 1, wherein the first endpoint is a single-decode endpoint and the second endpoint is a multi-decode endpoint.

3. The method of claim 1, wherein performing contextual provisioning to increase the quality of the conference comprises sending instructions to the first media handling resource.

4. The method of claim 3, wherein the instructions instruct the first media handling resource to send only audio data.

5. The method of claim 3, wherein the feedback data comprises information related to at least one of:
service provider information; and
one or more dynamic variables.

6. The method of claim 5, wherein service provider information comprises at least one of:
capacity by region by time of day;
cost per region by time of day;
feature set purchased by a service provider; and
feature set purchased by an endpoint customer.

7. The method of claim 5, wherein dynamic variables comprise at least one of:
network capabilities;
network capacity;
moderator control;
user control;
conference call quality;
addition of one or more new endpoints to the conference call; and
removal of one or more existing endpoints from the conference call.

8. The method of claim 2, wherein performing contextual provisioning comprises sending instructions to the first media handling resource, wherein the instructions instruct the first media handling resource to transcode a composite stream from two or more individual streams of data.

9. The method of claim 2, wherein performing contextual provisioning comprises sending instructions to the media handling resource, wherein the instructions instruct the first media handling resource to provide multiple separate streams to the first endpoint.

10. A computer storage media comprising computer executable instructions that, when executed by at least one processor, perform a method for performing contextual provisioning in a video conference, the method comprising:
receiving, at a decision engine, information about a first call from a first endpoint of the video conference;
sending instructions to route the first call to an identified first media handling resource, wherein the first media handling resource is identified based upon proximity to the first endpoint;
receiving, at the decision engine, information about a second call from a second endpoint of the video conference, wherein the information about the first call and the information about the second call indicate that the second endpoint supports a set of capabilities different from the first endpoint;
sending instructions to route the second call to an identified second media handling resource, wherein the second media handling resource is identified based upon proximity to the second endpoint;
receiving feedback data related to the conference;
analyzing the feedback data; and
based upon the analysis, performing contextual provisioning to increase the quality of the conference.

11. The computer readable medium of claim 10, wherein performing contextual provisioning comprises providing instructions to the first media handling resource to encode a single composited stream that groups multiple images from multiple data streams of a high quality multiscreen endpoint.

12. The computer readable medium of claim 10, wherein performing contextual provisioning comprises providing instructions to the first media handling resource to composite a low quality video in a smaller view.

13. The computer readable medium of claim 11, wherein the feedback data comprises information related to at least one of:
service provider information; and
one or more dynamic variables.

14. The computer readable medium of claim 10, wherein performing contextual provisioning comprises providing instructions to transcode a composite stream from two or more individual streams of data.

15. The computer readable medium of claim 14, performing contextual provisioning comprises providing instructions to the second media handling resource to provide multiple streams of data to the second endpoint.

16. The computer readable medium of claim 10, wherein the decision criteria comprises information related to at least one of:
moderator control;
user control;
number of cameras and screens for an endpoint;
endpoint codec type;
endpoint codec settings;
endpoint type;
network information; and
endpoint capabilities.

17. A system for conference calls, the system comprising:
a decision engine for performing steps comprising:
receiving, at a decision engine, information about a first call from a first endpoint of the video conference;
sending instructions to route the first call to an identified first media handling resource, wherein the first media handling resource is identified based upon proximity to the first endpoint;
receiving, at the decision engine, information about a second call from a second endpoint of the video conference, wherein the information about the first call and the information about the second call indicate that the second endpoint supports a set of capabilities different from the first endpoint;
sending instructions to route the second call to an identified second media handling resource, wherein the second media handling resource is identified based upon proximity to the second endpoint;
receiving feedback data related to the conference;
analyzing the feedback data; and
based upon the analysis, performing contextual provisioning to increase the quality of the conference.
the first media handling resource for performing steps comprising:
receiving a first input stream from the first endpoint;
providing the first input stream to the second media handling resource;
receiving a second input stream and a third input stream from the second media handling resource;
receiving the first contextual provisioning instructions from the decision engine; and
providing the second input stream and the third input stream to the first endpoint according to the first contextual provisioning instructions; and
the second media handling resource for performing steps comprising:
receiving the second input stream from the second endpoint;
receiving the third input stream;
providing the second input stream and the third input stream to the first media handling resource, wherein the second input stream and the third input stream are provided as individual streams;
receiving the first input stream from the first media handling resource;
receiving the second contextual provisioning instructions from the decision engine; and
providing the first input stream to the second endpoint according to the second contextual provisioning instructions.

18. The system of claim 17, further comprising a first media transfer component, wherein providing the first input stream to the second media handling resource comprises sending the first input stream to the first media transfer component.

19. The system of claim 18, further comprising a second media transfer component, wherein providing the second input stream to the first media handling resources comprises sending the second input stream to the second media transfer component.

20. The system of claim 19, wherein providing the second input stream to the first endpoint according to the first contextual provisioning instructions further comprises:
creating a composite stream of data from the second input stream and an additional input stream; and
providing the composite stream to the first endpoint.
